(19) United States
(12) Patent Application Publication
(10) Pub. No.: US 2004/0134586 A1
(43) Pub. Date: Jul. 15, 2004

(54) PNEUMATICALLY ACTUATED ASSEMBLY APPARATUS AND METHOD OF ASSEMBLY

(76) Inventor: Lawrence J. Cook, Metamora, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/707,731

(22) Filed: Jan. 7, 2004

Related U.S. Application Data
(60) Provisional application No. 60/438,439, filed on Jan. 8, 2003.

(51) Int. Cl. B32B 31/00

(52) U.S. Cl. 156/60; 156/64; 156/391

(57) ABSTRACT

An assembly apparatus is provided for assembling two members, such as, for example a hose and a hose clamp. The assembly apparatus includes a base having first and second independently extendible members. A dispenser, joined to a third independently extendible member, is operatively connected to the base. A pneumatic or hydraulic control system actuates each of the first, second and third independently extendible members, such as pneumatic cylinders, to position the dispenser relative to the hose and hose clamp. Generally, the first and second independently extendible members extend along a first axis while the third independently extendible member extends along a second axis and the second axis is generally orthogonal to the first axis. The present invention joins the hose and hose clamp without the need to distort the generally smooth outer surface of the hose. A method of assembling the two members is also disclosed.

### CROSS REFERENCE TO RELATED APPLICATIONS

This application claims priority to U.S. provisional application 60/438,439 filed on Jan. 8, 2003, which is incorporated herein by reference in its entirety.

### FIELD OF INVENTION

The present invention relates generally to a pneumatically actuated assembly apparatus and method for assembling a hose and hose clamp and, more particularly, to an apparatus and method of assembly that applies adhesive to an outer surface of a hose, positions a hose clamp about the hose and mates the hose and hose clamp together.

### BACKGROUND OF THE INVENTION

High volume manufacturing environments are constantly demanding easier, more cost effective manufacturing techniques to improve their assembly operations. One such area demanding improvement is the automotive field employing radiator hose and hose clamp assemblies. In mass production environments, it is preferable for the hose clamp to be secured to an outer surface of the radiator hose prior to insertion on an assembly line into an engine. Traditionally, to facilitate an effective connection of the hose and hose clamp the typically smooth outer surface of the hose is distorted, roughened or chemically etched to create a minimally porous outer surface. The porous outer surface absorbs an adhesive to facilitate a more effective connection between the hose and the hose clamp. An automated process that quickly and easily joins the hose and hose clamp without the need for distorting the outer surface of the hose and minimizes the amount of manual intervention from an operator is greatly desired in the mass production environment.

Further, most complex machinery used to automate a typically manual process are large and usually unreliable. Accordingly, there exists a need for a compact, reliable and self-controlled assembly apparatus that can simply assemble two members such as a radiator hose and a hose clamp.

### BRIEF SUMMARY OF THE INVENTION

An assembly apparatus is provided for joining first and second members. The assembly apparatus includes a base having first and second independently extendible members. A dispenser is operatively connected to the base and also joined to a third independently extendible member. Each of the independently extendible members is actuated by a control system to position the dispenser relative to the first and second members.

A method of assembling the first and second members is also disclosed. The first step includes providing an apparatus having a first independently extendible member, a second independently extendible member, a third independently extendible member, and a dispenser operatively connected to the third independently extendible member. Next, the first and second members to be assembled are inserted into assembly fixtures. The first independently extendible member is extended to orient the dispenser about the first member. Next, an adhesive is dispensed from the dispenser to an outer surface of the first member. The third independently extendible member is retracted to align the first and second members. The second independently extendible member is extended and compression is applied to join the first and second members.

Among other advantages, the inventive assembly apparatus is compact and readily configurable to repetitively assemble two members, such as a hose and hose clamp. Another advantage is that the assembly apparatus efficiently assembles a hose and hose clamp with a minimal amount of manual intervention and without the need to distort the smooth outer surface of the hose.

### BRIEF DESCRIPTION OF THE DRAWINGS

The features and inventive aspects of the present invention will become more apparent upon reading the following detailed description, claims, and drawings, of which the following is a brief description:

FIG. 1 is a plan view of an assembly apparatus, according to an embodiment of the present invention, with a cover removed for clarity.

FIG. 2 is a plan view of the assembly apparatus of FIG. 1 having a first independently extendible member extended.

FIG. 3 is a plan view of the assembly apparatus of FIG. 2 having a second independently extendible member also extended.

FIG. 4 is an end view of the assembly apparatus having a third independently extendible member extended and the dispenser removed for clarity.

FIG. 5 is an end view of the assembly apparatus with the third independently extendible member retraced and the dispenser removed for clarity.

### DETAILED DESCRIPTION OF THE INVENTION

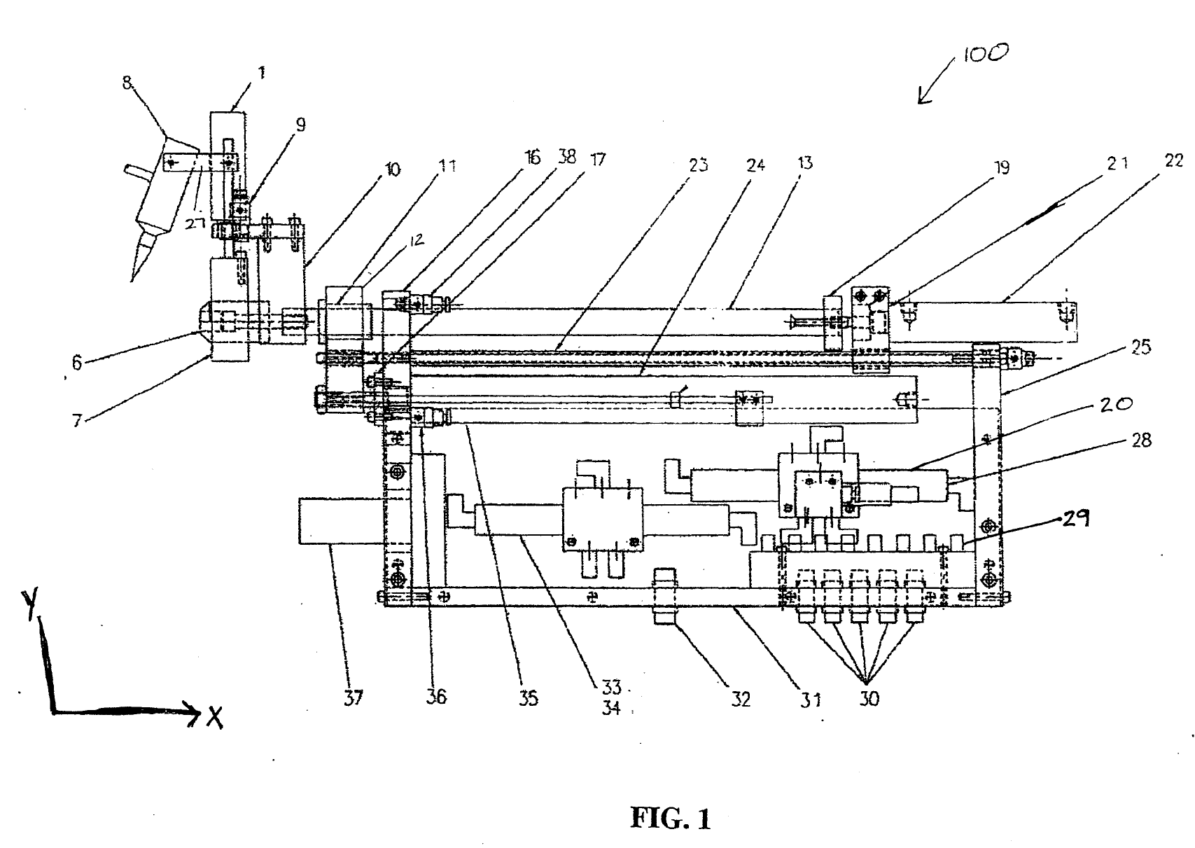

Referring to FIGS. 1-5, an assembly apparatus 100 according to an embodiment of the present invention is shown. A plan view of assembly apparatus 100 is illustrated in FIGS. 1-3 with a cover removed for clarity. FIG. 1 illustrates assembly apparatus 100 in a home position. Assembly apparatus 100 includes side plate 31 and first and second end plates 16, 25 to define a base for apparatus 100. Each of the plates 16, 25 and 31 are fastened together using bolts or the like. Assembly apparatus 100 also includes a shaft 23 fastened to both the first and second end plates 16, 25 at opposite ends to further define the base.

Within the base are first and second independently extendible members 24 and 22 generally extendible along the X-axis shown in FIGS. 1-3. First independently extendible member 24 is threaded at one end and attached to first end plate 16. The opposite end is attached to a first plate 12. A threaded rod 14 extends between first plate 12 and a fixed block 21. Threaded rod 14 also extends through first end plate 16. A support rod 15 is threaded to first plate 12 to join first plate 12 to a first intermediate plate 17.

Second independently extendible member 22 is also threaded at one end and attached to fixed block 21. Fixed block 21 also receives shaft 23 that joins the first and second end plates 16, 25, as described above, to define the base. Further, the opposite end of second independently extendible member 22 is connected to shaft 13. Shaft 13, while attached at one end to second independently extendible member 22, is attached at the opposite end to block 10 with a fastener such as a bolt or the like. Further, the same fastener utilized to join shaft 13 to block 10 is also utilized to join block 10 to a mandril 6. Shaft 13 also extends through first plate 12 and first end plate 16. First plate 12 includes at least one bearing member 11 slidably received over shaft 13. Bearing member 11 is preferably an oil-impregnated sleeve bearing that is press-fit into first plate 12.

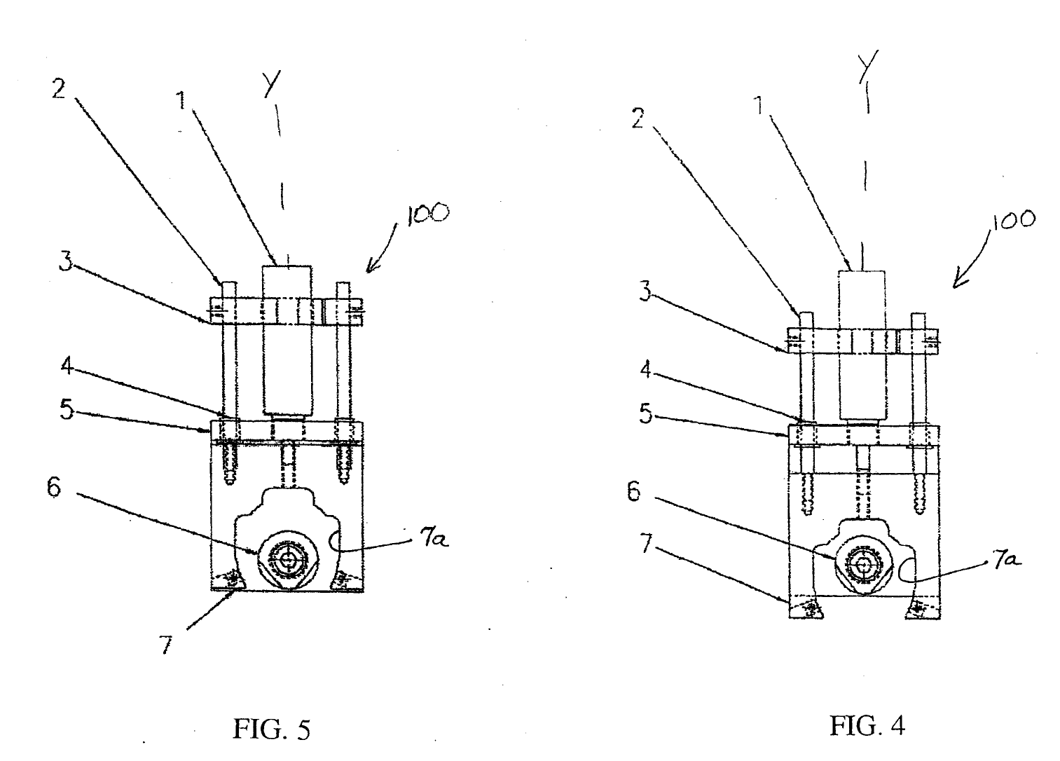

In the present invention, a second assembly fixture 7 is designed to accommodate a second member (not shown), such as a hose clamp. In the embodiment shown in FIGS. 4 and 5, an inner profiled surface 7a of second assembly fixture 7 is shaped to accommodate the profile of a typical adjustable hose clamp. A first assembly fixture (not shown) receives a first member (also not shown), such as a hose. The preferred function of assembly apparatus 100 is to join the first and second members. In an exemplary embodiment, the first assembly fixture is generally not aligned with the second assembly fixture 7. Instead, the first assembly fixture is positioned along a Y-axis vertically offset from the second assembly fixture 7. The offset positioning of the assembly fixtures facilitates the easy manual insertion of the hose and hose clamp into the fixtures by an operator.

Referring to FIGS. 4-5, second assembly fixture 7 is connected to a dispenser 8 and a third independently extendible member 1. A fixed plate 5 is fastened to block 10 by a bolt or the like. Shafts 2 are received in holes of fixed plate 5 and are joined to a second plate 3 by a pair of set screws or the like. Second plate 3, shafts 2 and second assembly fixture 7 are extendible in relation to fixed plate 5 by third independently extendible member 1 and third independently extendible member 1 is operatively connected to the base. Fixed plate 5 includes at least one bearing member 4 slidably received over each of shafts 2. Bearing member 4 is preferably an oil-impregnated sleeve bearing that is press-fit into fixed plate 5.

Attached to second plate 3 is dispenser 8. Second plate 3 includes a retaining mechanism 27 to retain dispenser 8. However, dispenser 8 may also be attached by fasteners such as set screws, bolts or the like. It is contemplated by the present invention that the attachment of dispenser 8 to second plate 3 permits adjustment of dispenser 8 vertically along the Y-axis and also in other directions desired by one skilled in the art. In an embodiment, dispenser 8 dispenses a small amount of adhesive or glue onto an outer surface of the first member (e.g. a hose). However, the dispenser may dispense any material as deemed necessary by an operator of assembly apparatus 100. In FIGS. 4-5, dispenser 8 is removed for clarity.

In an embodiment of the present invention, first, second and third independently extendible members 24, 22, 1 are pneumatically or hydraulically operated. Therefore, a control system 30, as described herein, includes a means of distributing fluid power between a source of pressurized fluid and first, second and third independently extendible members 24, 22, 1. However, it will be appreciated that other extendible devices, such as a motor driven screw mechanism, may be used in place of first, second and third independently extendible members 24, 22, 1 without departing from the scope of the present invention. In such a configuration, control system 30 may include specific devices, such as a programmable logic controller (PLC), for controlling operation of the extendible members 24, 22 and 1.

Referring to FIGS. 1-3, assembly apparatus 100 is provided with a main port 32 to which the source of pressurized fluid, such as compressed air, is connected. Main port 32 is provided in direct communication with first, second and third three-way valves 33, 28 and 34, which are generally, but not necessarily, pneumatically operated to simplify operation of assembly apparatus 100. For clarity, the conduits (e.g. flexible tubing or hose) provided between port 32 and valves 33, 28 and 34 are not illustrated in FIGS. 1-3. Further, an exemplary embodiment of the present invention includes a manifold 29. Manifold 29 is positioned between the fluid supply at main port 32 and each of the valves 33, 28 and 34 to regulate the supply of fluids to each of the valves 33, 28 and 34.

Although the described control system 30 is configured with fluid power operated valves to distribute a pressurized fluid through assembly apparatus 100, it is not necessarily limited thereto. Alternatively, other suitable fluid power distribution devices, such as electromechanically operated valves, are also within the scope of this invention.

Operation of the inventive assembly apparatus 100 will be described herein with reference to FIGS. 1-5. Provided a source of air is connected to assembly apparatus 100 at main port 32 and the first and second members (e.g. a hose and hose clamp) are manually inserted into the first assembly fixture and second assembly fixture 7 respectively, the operating sequence is initiated by an operator selectively supplying a signal or pulse of air to first three-way valve 33. The operator may initiate this pulse of air by simultaneously depressing a pair of pneumatically operated safety switches, or by any other suitable means known in the art.

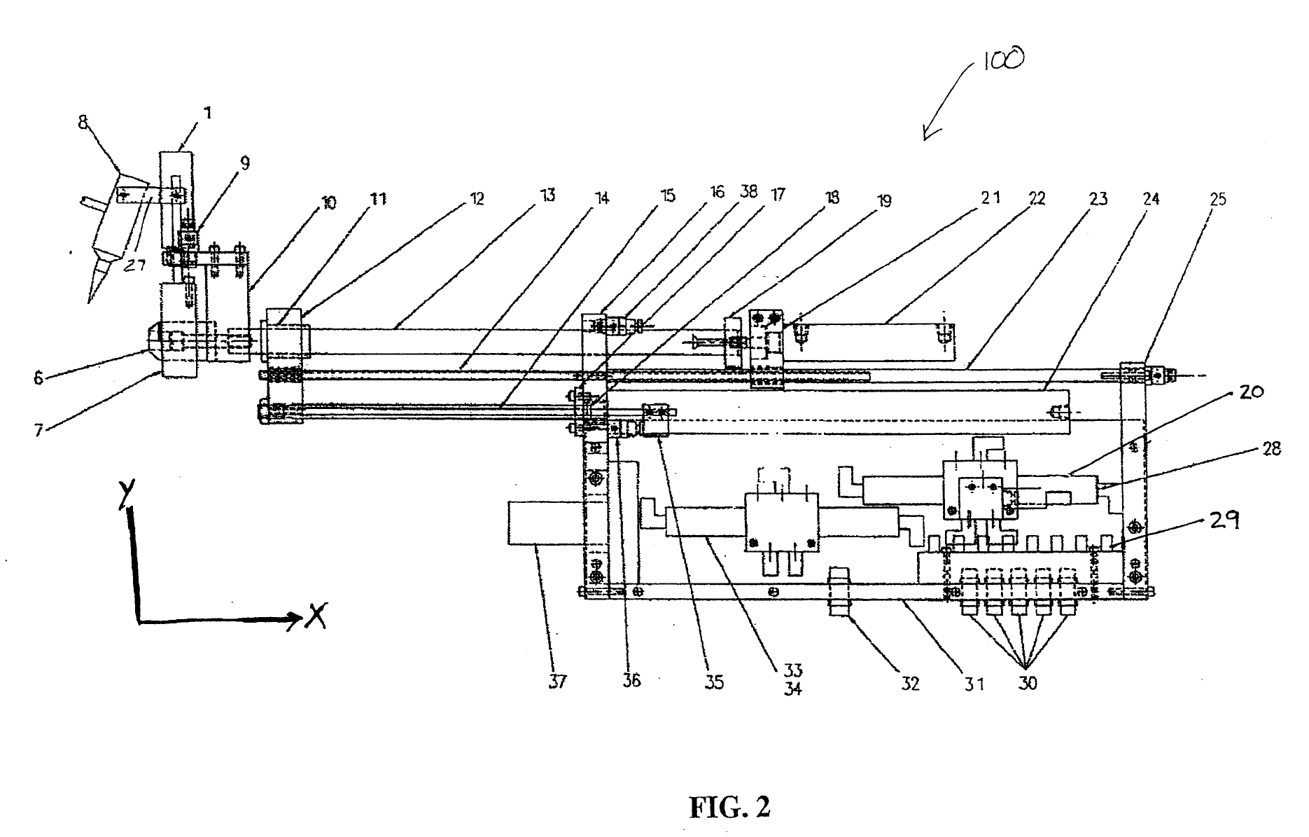

Upon receipt of a signal or pulse of air, first three-way valve 33 shifts and supplies air to first independently extendible member 24. Regarding first independently extendible member 24, the receipt of air causes it to extend first plate 12 away from first end plate 16 along the X-axis, as illustrated in FIG. 2. The distance first independently extendible member 24 extends first plate 12 is selectively variable by adjusting the position of a first collar 18 along support rod 15. As shown in FIG. 2, extension of first independently extendible member 24 and first plate 12 stops when first collar 18 abuts first intermediate plate 17. Once first independently extendible member 24 is fully extended, dispenser 8 is positioned or oriented appropriately about the first member for dispersing an adhesive.

When first collar 18 abuts first intermediate plate 17, a limit switch actuator 35 is actuated and depresses a first two-way limit switch 36. An air signal is sent from first limit switch 36 through control system 30 to an external dispensing system (not shown). The dispensing system receives the signal or pulse of air and begins its own sequence to transfer glue to dispenser 8. In an embodiment of the present invention, dispenser 8 applies a bead of glue or adhesive to an outer surface of the first member (e.g. hose). An exemplary glue is a cyanoacrylate or the like commerically available from Loctite® located at 2455 Featherstone Road, Auburn Hills, Mich. 48326. Additionally, Loctite® also supplies glue dispensing systems such as Single Function Controller 98023, which may be provided in communication with dispenser 8 to facilitate application of the adhesive. However, the present invention may incorporate any type of dispensing system to dispense adhesive or any other type of material.

Once the adhesive bead is applied to the outer surface of the first member or hose, the dispensing system sends a signal or air pulse back to control system 30 to second three-way air valve 28. Upon receipt of the signal or pulse of air, three-way air valve 28 shifts and supplies air to third independently extendible member 1. Regarding third independently extendible member 1, the receipt of air causes it to retract and move second plate 3 away from fixed plate 5 along the Y-axis, as illustrated in FIGS. 4-5. Further, second assembly fixture 7 having the hose clamp is also moved vertically upward along the Y-axis. As shown in FIG. 5, retraction of third independently extendible member 1 and second plate 3 stops when third independently extendible member 1 fully retracts and depresses two-way limit switch 9. Limit switch 9 sends a signal or air pulse to third three-way valve 34. When third independently extendible member 1 is fully retracted the hose and hose clamp are aligned.

The use of terms extend and retract are not intended to be limiting. One skilled in the art can practice features of the present invention utilizing alternative retracting and extending orientations of the extendible members 24, 22 and 1.

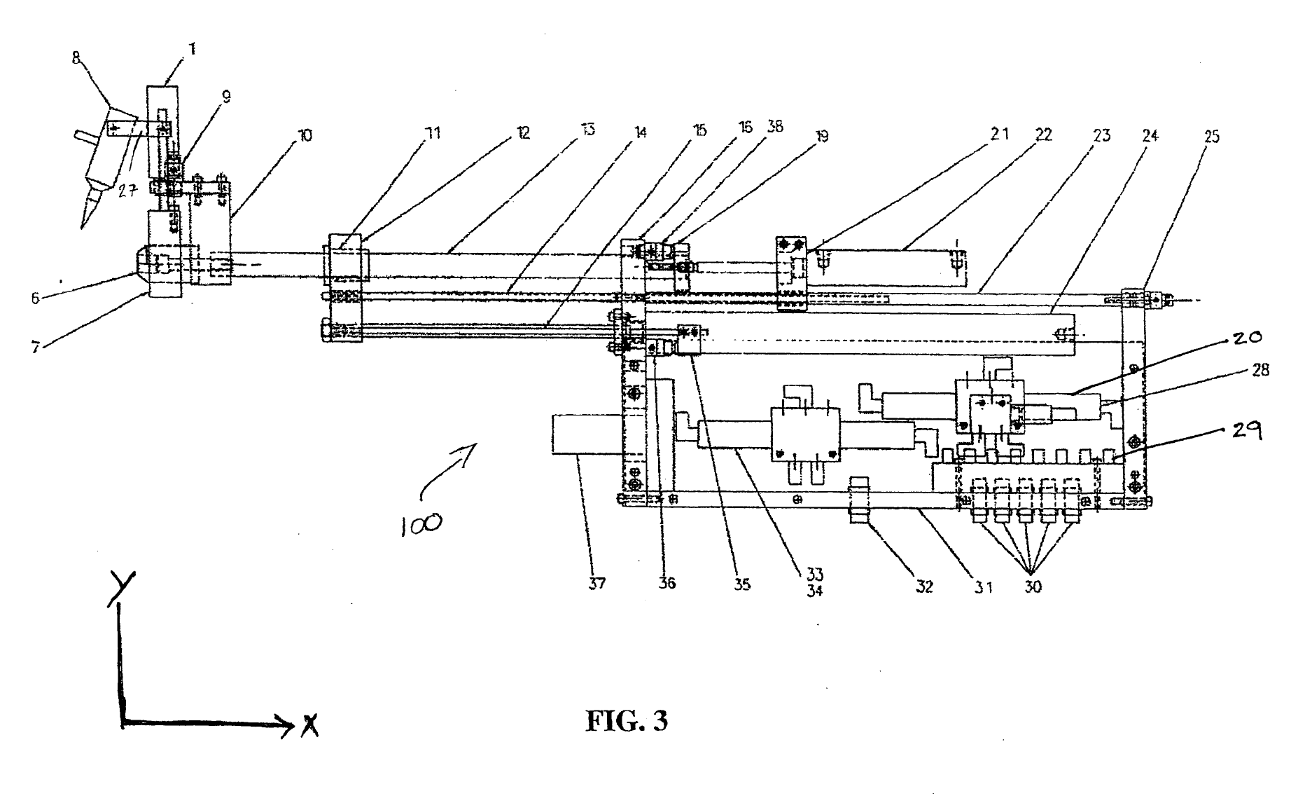

Upon receipt of the signal or pulse of air, third three-way air valve 34 shifts and supplies air to second independently extendible member 22. Regarding second independently extendible member 22, the receipt of air causes it to extend and move block 10 away from plate 12 along the X-axis, as illustrated in FIG. 3. Further, dispenser 8 is moved away from the hose and the hose clamp is positioned over the hose and glue bead. Also, the extension of second extendible member 22 inserts mandril 6 into the hose and positions the hose clamp over the hose. As shown in FIG. 3, extension of second independently extendible member 22 and block 10 stops when a second collar 19 abuts first end plate 16

When second collar 19 abuts first end plate 16, a second two-way limit switch 38 is depressed. An air signal is sent from second limit switch 38 to a pneumatic timer 37. Timer 37 initiates and will release an air signal after a set amount of time. In an embodiment of the present invention, the preset amount of time is approximately 10 seconds to permit the adhesive to cure and the first and second members to be adhered together.

Also, when second collar 19 abuts first end plate 16, an air signal is sent from second limit switch 38 to second valve 28. Second valve 28 shifts from supplying air to retract third independently extendible member 1 to supplying air to extend third independently extendible member 1. The third independently extendible member extends and presses the second member or hose clamp onto the bead of adhesive, hose and mandril 6. Mandril 6 is received within the first member or hose to prevent collapse of the hose when subjected to compression from the third independently extendible member 1. Third independently extendible member 1 will continue to compress the first and second members together until pneumatic timer 37 expires and sends an air signal.

Applying compression or downward force upon the first and second members minimizes or eliminates the need, as described above in the Background, to distort the generally smooth outer surface of the hose. Instead, the present invention applies an appropriate amount of force to generate an effective adherence between the hose and the hose clamp. An insufficient amount of force will result in an ineffective assembly of the two members. Further, force or compression above the appropriate amount will distribute the adhesive and also result in an ineffective assembly of the two members.

Upon expiration of the preset amount of time, timer 37 sends the air signal to first valve 33, second valve 28 and third valve 34. Further, timer 37 sends an air signal to a fourth valve 20. Fourth valve 20 exhausts air from the third independently extendible member 1 and accordingly, force or compression is no longer exerted upon the first and second members. A delay is incorporated into first and third valves 33, 34. Fourth valve 20 exhausts third independently extendible member 1 and then first and third valves 33, 34 switch to retract first and second independently extendible members 24, 22. The delay prevents the retraction of first and second independently extendible members 24, 22 from interfering with the assembled first and second member in the first assembly fixture. Next, second valve 28 switches to extend third independently extendible member 1. In this configuration, all items are returned to their home positions, as shown in FIG. 1 and the operating cycle is deemed complete. The joined first and second members may be manually or automatically ejected or removed from the first assembly fixture.

Although certain preferred embodiments of the present invention have been described, the invention is not limited to the illustrations described and shown herein, which are deemed to be merely illustrative of the best modes of carrying out the invention. A person of ordinary skill in the art will realize that certain modifications and variations will come within the teachings of this invention and that such variations and modifications are within its spirit and the scope as defined by the claims.

1. an assembly apparatus for joining first and second members comprising:
a base including first and second independently extendible members;
a dispenser joined to a third independently extendible member, said third independently extendible member operatively connected to said base; and
wherein said first, second and third independently extendible members are actuated by a control system to position said dispenser relative to the first and second members.

2. The apparatus of claim 1, wherein said control system is a pneumatic control system.

3. The apparatus of claim 2, wherein said control system includes at least one inlet port for connecting the assembly apparatus to a source of compressed air.

4. The apparatus of claim 3, wherein said control system includes at least one valve for selectively routing air between said inlet port and each of said first, second and third independently extendible members.

5. The apparatus of claim 4, further including a pneumatic timer operatively connected to said valve.

6. The apparatus of claim 2, wherein said first, second and third independently extendible members are pneumatic cylinders.

7. The apparatus of claim 1, wherein said first and second independently extendible members are generally extendible along a first axis and said third independently extendible member is generally extendible along a second axis, said second axis being generally orthogonal to said first axis.

8. The apparatus of claim 1, wherein said control system is a hydraulic control system.

9. The apparatus of claim 1, wherein said second independently extendible member includes a mandril and, when said second independently extendible member is extended, said mandril is received by the first member to facilitate joining of the members.

10. The apparatus of claim 1, further including assembly fixtures to receive the first and second members.

11. The apparatus of claim 1, wherein said dispenser expels an adhesive upon a surface of one of the first or second members.

12. A method of assembling first and second members comprising the steps of:
providing an apparatus that includes a first independently extendible member, a second independently extendible member, a third independently extendible member and a dispenser operatively connected to the third independently extendible member;
inserting the first and second members into assembly fixtures;
extending the first independently extendible member to orient the dispenser about the first member;
dispensing an adhesive from the dispenser upon an outer surface of the first member;
retracting the third independently extendible member to align the first and second members;
extending the second independently extendible member to join the first and second members; and
applying compression to the first and second members.

13. The method of claim 12, wherein the extending and retracting steps of the first, second and third independently extendible members are controlled by a pneumatic control system.

14. The method of claim 12, wherein the compressing step is controlled by a pneumatic timer.

15. The method of claim 12, wherein the step of extending the second independently extendible member includes inserting a mandril through the first member.

16. The method of claim 12, wherein the steps of extending and retracting the first, second and third independently extendible members are controlled by a hydraulic control system.

17. The method of claim 12, further including the step of retracting the first and second independently extendible members and extending the third independently extendible member to return the assembly apparatus to a home position.

18. The method of claim 17, wherein compression applied to the first and second members is minimized before retracting the first and second independently extendible members.
